(19) United States
(12) Patent Application Publication
(10) Pub. No.: US 2025/0245905 A1
(43) Pub. Date: Jul. 31, 2025

(54) METHOD FOR SIMULATING IMAGES WITH ABERRATIONS BASED ON RAY TRACING

(71) Applicant: GM GLOBAL TECHNOLOGY OPERATIONS LLC, Detroit, MI (US)

(72) Inventors: Tzvi Philipp, Bet Shemesh (IL); Ofer Bar-Shalom, Kiryat Ono (IL); Eran Kishon, Hod Hasharon (IL); Michael Slutsky, Kefar-Saba (IL)

(73) Assignee: GM GLOBAL TECHNOLOGY OPERATIONS LLC, Detroit, MI (US)

(21) Appl. No.: 18/423,540

(22) Filed: Jan. 26, 2024

(51) Int. Cl. G06T 15/06; G06T 5/20

(52) U.S. Cl. CPC G06T 15/06; G06T 5/20

(57) ABSTRACT

A method for simulating images with aberrations, or a non-transitory computer-readable storage medium on which are recorded instructions. The method includes ray tracing planes of objects to produce plane images, estimating point spread function from the ray tracing, and creating one or more perceived images. The method may include feeding a ray-tracing simulator with one more synthetic impulse images or scenes. The method may include feeding the perceived images into a perception pipeline and generating synthetic imagery from the plane images and the perceived images.

### INTRODUCTION

The present disclosure relates to methods for simulating images with aberrations based on ray tracing. This may be used for autonomous vehicles or other neural networks requiring synthetic images for training vision. Currently no technologies exist to help with simulating images on aberrations based on ray tracing.

### SUMMARY

A method for simulating images with aberrations, or a non-transitory computer-readable storage medium on which are recorded instructions. The method includes ray tracing planes of objects to produce plane images, estimating point spread function from the ray tracing, and creating one or more perceived images. The method may include feeding the perceived images into a perception pipeline and generating synthetic imagery from the plane images and the perceived images.

The method may include implementing a blurring effect and implementing a noise tradeoff. The method may also include providing an actual imaging sensor of a vehicle, and the imaging sensor of the vehicle is located within a cabin of the vehicle. The method may further include incorporating optical effects into the generated synthetic imagery, test-drives may not be needed for data collection due to the generated synthetic imagery, and rendering one or more photo-realistic scenes on the generated synthetic imagery. The method may include feeding a ray-tracing simulator with one more synthetic impulse images or scenes.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of a connectivity system for simulating images with aberrations based on ray tracing.

FIG. 2 is a schematic flow chart diagram of a method, or methods, for simulating images with aberrations based on ray tracing.

### DETAILED DESCRIPTION

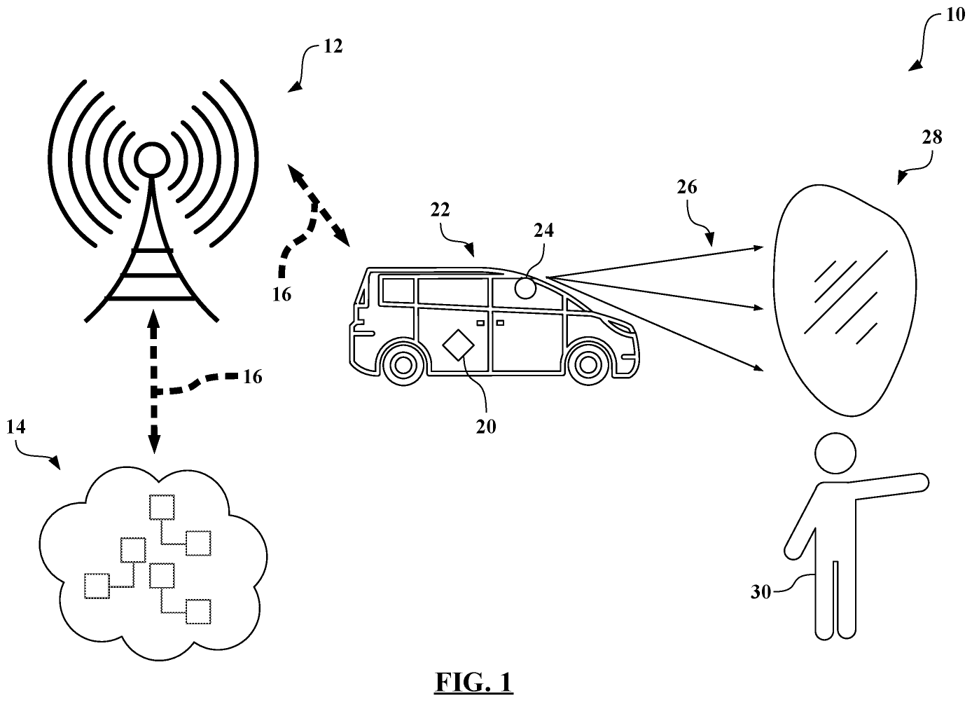

Referring to the drawings, like reference numbers refer to similar components, wherever possible. FIG. 1 schematically illustrates a connectivity network or connectivity system 10. The connectivity system 10 includes numerous components, only some of which are listed, and/or shown, herein.

A remote or cellular communications system, or cellular network 12, which may be representative of many types of communications protocols, including, without limitation: cellular, satellite, Wi-Fi, Bluetooth, ultra-wideband (UWB) or other communications recognizable to those having ordinary skill in the art. UWB is a radio-based communication technology for short-range use and fast and stable transmission of data.

A centralized location 14 is shown highly schematically, but may be representative of many different structures, clouds, servers, or elements, as will be recognized by skilled artisans. The centralized location 14 represents systems that communicate with some or all of the other systems and/or objects described herein. The centralized location 14 includes numerous controllers 20. Additionally, the centralized location 14 may be a back office (BO) of the manufacturer of the vehicles.

Several transfer protocols or transfers 16 are schematically illustrated. These transfers 16 may include, without limitation: cellular, Wi-Fi, wired networks, over-the-air (OTA), other transport protocols, including machine to machine (M2M), or other telematics equipment, or other systems recognizable by those having ordinary skill in the art. M2M systems use point-to-point communications between machines, sensors, and hardware over cellular, Wi-Fi, or wired networks.

The drawings and figures presented herein are diagrams, are not to scale, and are provided purely for descriptive purposes. Thus, any specific or relative dimensions or alignments shown in the drawings are not to be construed as limiting. While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

The term vehicle is broadly applied to any moving platform. Vehicles into which the disclosure may be incorporated include, for example and without limitation: passenger or freight vehicles; autonomous driving vehicles; industrial, construction, and mining equipment; and various types of aircraft.

All numerical values of parameters (e.g., of quantities or conditions) in this specification, including the appended claims, are to be understood as being modified in all instances by the term “about,” whether or not the term actually appears before the numerical value. About indicates that the stated numerical value allows some slight imprecision (with some approach to exactness in the value; about or reasonably close to the value; nearly). If the imprecision provided by about is not otherwise understood in the art with this ordinary meaning, then about as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

When used herein, the term “substantially” often refers to relationships that are ideally perfect or complete, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

A generalized control system, computing system, or controller 20 is operatively in communication with relevant components of all systems, and recognizable by those having ordinary skill in the art. The controller 20 includes, for example and without limitation, a non-generalized, electronic control device having a preprogrammed digital computer or processor, a memory, storage, or non-transitory computer-readable storage medium used to store data such as control logic, instructions, lookup tables, etc., and a plurality of input/output peripherals, ports, or communication protocols.

Furthermore, the controller 20 may include, or be in communication with, a plurality of sensors. The controller 20 is configured to execute or implement all control logic or instructions described herein and may be communicating with any sensors described herein or recognizable by skilled artisans. Any of the methods described herein may be executed by one or more controllers 20.

The connectivity system 10 may be used to execute methods of simulating images based on aberrations based on ray tracing. In 3-D, or 2-D, computer graphics, ray tracing is a technique for modeling light transport for use in a wide variety of rendering algorithms for generating digital images and photo-realistic scenes. Ray tracing can simulate a variety of optical effects, such as reflection, refraction, soft shadows, scattering, depth of field, motion blur, caustics, ambient occlusion and dispersion phenomena (such as chromatic aberration).

This technique is for generating one or more fundamental images used to train a neural network (NN), which saves the long process of collecting real data. Instead of actual images captured by the system and having to annotate the data to train the neural network, these systems/methods/techniques avoid the need for test drives of one more or move vehicles 22. By using synthetic images that have been modified by the optical aberration information—i.e., point spread function (PSF)—the systems can generate more realistic images with the added benefit that since it is synthetic no further annotation efforts are needed. The synthetic data contains all the information—labels or identification of the object and location in 3D space automatically—by the nature in how synthetic data is generated. This information is then used to train the neural network.

Ray tracing can also be used to trace the path of sound waves in a similar fashion to light waves, making it a viable option for more immersive sound design in video games by rendering realistic reverberation and echoes. In fact, any physical wave or particle phenomenon with approximately linear motion can be simulated with ray tracing. Aberrations may be a departure from what is normal, usual, or expected, typically one that is unwelcome.

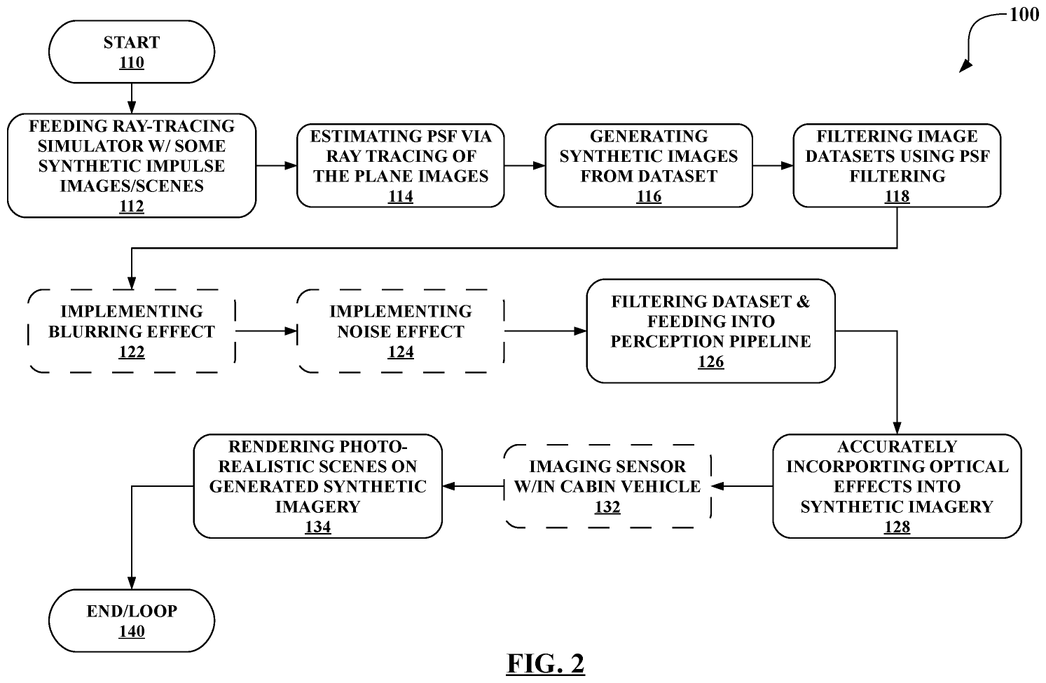

FIG. 2 is a schematic flow chart diagram of a method 100, or methods, for simulating images with aberrations based on ray tracing. One or more of the methods described herein may be executed by the controller 20, including the non-transitory computer-readable storage medium, or other structures or equipment recognizable to skilled artisans. All steps described herein may be optional, in addition to those explicitly stated as such, and all steps described may be reordered or removed. Any of the methods described herein may store the data in the centralized location 14 via the connectivity system 10.

Vehicle 22 is shown in FIG. 1, but there may be other vehicles 22 that are not shown. An imaging sensor 24 is shown in FIG. 1, highly schematically, and note the imaging sensor 24 may be located in any location of the vehicle 22. The imaging sensor 24 may be any of the types listed, or as would be recognized by those having ordinary skill in the arts, including, without limitation: image sensors, radar sensors, LiDAR sensors, GPS sensors, and/or ultrasonic sensors. The imaging sensors 24 may include embedded MEMS technology or other technologies recognizable to those having ordinary skill in the arts.

FIG. 1 schematically demonstrates sensor capture lines 26. These may be used to capture a scene 28. Note that the scene 28 may be composed of many elements, both real and modified, as would be recognizable to those having ordinary skill in the arts. Note that the scene 28 may include one or more humans 30.

Step 110: START. At step 110 the method 100 initializes or starts. Method 100 may begin operation when called upon by one or more controllers 20, may be constantly running, or may be looping iteratively.

Step 112: FEEDING A RAY-TRACING SIMULATOR WITH SOME SYNTHETIC IMPULSE IMAGES/SCENES. At step 112, method 100 feeds the ray-tracing simulator with some synthetic impulse images/scenes.

Skilled artisans will recognize how the ray-tracing simulator may be fed with one or more synthetic images. This may include, without limitation, producing one or more plane images—or source images—which may be used to produce one or more generated synthetic imageries. This includes, without limitation, generating synthetic impulse scenes data that, generally, assumes perfect optical performance, and translating the synthetic scene that mimics the real world with three-dimensional (3D) objects distributed randomly in a 3D space to be mapped to a two-dimensional (2D) image. The plane images may be stacked to create a three-dimensional space.

Step 114: ESTIMATING POINT SPREAD FUNCTION VIA RAY TRACING OF THE PLANE IMAGES. At step 114, method 100 estimates point spread function (PSF) via ray tracing of the plane images. Generating the PSF, which may be sampled at multiple locations in the frame. Note that this process is repeated per color component (R, G, B) and per depth—i.e., assuming the synthetic impulse image is placed at different distances from the imager. For example, and without limitation, the synthetic impulse image may be between 10 meters and 100 meters in steps of 10 meters.

Ray tracing is described, in detail, above. The PSF describes the response of a focused optical imaging system to a point source or point object. A more general term for the PSF is the system's impulse response, the PSF is the impulse response or impulse response function (IRF) of a focused optical imaging system.

This includes, without limitation, generating a 2D PSF map per each depth over the 3D volume. These may be 2D slices XY taken every Z depth that create a 2D map of all the optical aberration generated by the optics. This is the PSF library of aberrations. Steps 112 and 114 may be combined by their mutual Z locations to mix the associated XY aberrations with the mutual XY image.

Step 116: GENERATING SYNTHETIC 3D IMAGES FROM THE DATASET. At step 116, method 100 generates synthetic 3D-rendered images for a dataset. These may, preferably, be photo-realistic images. Additionally, each image in the dataset is associated with a per-pixel depth map. This may further include creating one or more perceived images.

Step 118: FILTERING THE IMAGES IN THE DATASET USING THE PSF FILTER SET. At step 118, method 100 filters the images in the dataset. First, the imaging sensor 24, or actual imaging sensor 24, would need to know where the objects are relative themselves. Each group of pixels is filtered with a PSF filter according to its depth, which is extracted from the depth map. Combining the filtered pixels—each corresponding to a different spatial location within the frame—back into a unified image.

The PSF may be tuned to register the objects being picked up. A predictable perception pipeline for an autonomous vehicle system may be developed, and may include, without limitation, predicting time variations based on the intermediate results, like proposals and raw points. Additional elements of the perception pipeline will be recognizable to those having ordinary skill in the art.

Optional Step 122: IMPLEMENTING A BLURRING EFFECT. At optional step 122, method 100 may implement a blurring effect. Blurring will be understood by those having ordinary skill in the art. Blurring may be, simply, one aberration—focus or lack thereof—of numerous other aberrations, these include, without limitation: spherical, coma, astigmatism, tilt, chromatic (longitudinal and lateral) and irregularity.

Optional Step 124: IMPLEMENTING A NOISE EFFECT. At optional step 124, method 100 may implement a noise tradeoff or effect. Generally, as will be recognized by those having ordinary skill in the art, noise tradeoff refers to increasing the information rate, the signal-to-noise ratio and the allocated bandwidth may be traded off against each other.

Step 126: FILTERING DATASET AND FEEDING INTO PERCEPTION PIPELINE. At step 126, method 100 filters the dataset and feeds into the perception pipeline. Note that this may include, without limitation, generating synthetic imagery from both the plane images and the perceived images. Skilled artisans will recognize the different filters that may be applied to one or more datasets.

Step 128: ACCURATELY INCORPORATING OPTICAL EFFECTS INTO THE GENERATED SYNTHETIC IMAGERY. At step 128, method 100 incorporates one or more optical effects into the generated synthetic imagery. Skilled artisans will recognize what accurately may mean.

Optional Step 132: IMAGING SENSOR IS LOCATED WITHIN A CABIN OF THE VEHICLE. At optional step 132, method 100 may have the imaging sensor located within a cabin of the vehicle 22. Note that skilled artisan will recognize other locations for the imaging sensors 24, including, without limitation, exterior to the vehicle 22, and/or forward or backward of the vehicle 22.

Step 134: RENDERING ONE OR MORE PHOTO-REALISTIC SCENES ON THE GENERATED SYNTHETIC IMAGERY. At step 134, method 100 renders photo-realistic scenes onto, or within, the generated synthetic imagery. Note, importantly, that test-drives of the vehicle(s) 22 may not be needed for data collection due to the generated synthetic imagery and/or the photo-realistic scenes. Skilled artisans will recognize why test drives are not be needed for data collection.

Step 140: END/LOOP. At step 140, the method 100 ends or loops. Ending/looping may include proceeding back to start step 110 or waiting until called upon to run again, such as by one of the controllers 20 or another portion of the connectivity system 10.

The detailed description and the drawings or figures are supportive and descriptive of the subject matter herein. While some of the best modes and other embodiments have been described in detail, various alternative designs, embodiments, and configurations exist.

Furthermore, any examples shown in the drawings or the characteristics of various examples mentioned in the present description are not necessarily to be understood as examples independent of each other. Rather, it is possible that each of the characteristics described in one of the examples of an embodiment can be combined with one or a plurality of other desired characteristics from other examples, resulting in other examples not described in words or by reference to the drawings. Accordingly, such other examples fall within the framework of the scope of the appended claims.

1. A method for simulating images with aberrations, comprising:
ray tracing planes of objects to produce plane images;
estimating point spread function from the ray tracing;
creating one or more perceived images;
feeding the perceived images into a perception pipeline; and
generating synthetic imagery from the plane images and the perceived images.

2. The method of claim 1, further comprising:
feeding a ray-tracing simulator with one or more synthetic impulse images or scenes.

3. The method of claim 2, further comprising:
implementing a blurring effect; and
implementing a noise tradeoff.

4. The method of claim 3, further comprising:
providing an actual imaging sensor of a vehicle.

5. The method of claim 4, wherein the imaging sensor of the vehicle is located within a cabin of the vehicle.

6. The method of claim 5, further comprising:
incorporating optical effects into the generated synthetic imagery.

7. The method of claim 6, wherein test-drives are not needed for data collection due to the generated synthetic imagery.

8. The method of claim 7, further comprising:
rendering one or more photo-realistic scenes on the generated synthetic imagery.

9. The method of claim 8, further comprising:
generating the point spread function sampled at multiple locations in one or more frames.

10. The method of claim 1, further comprising:
providing an actual imaging sensor of a vehicle, wherein the imaging sensor of the vehicle is located within a cabin of the vehicle.

11. The method of claim 1, further comprising:
incorporating optical effects into the generated synthetic imagery,
wherein test-drives are not needed for data collection due to the generated synthetic imagery.

12. The method of claim 11, further comprising:
rendering one or more photo-realistic scenes on the generated synthetic imagery.

13. A non-transitory computer-readable storage medium on which is recorded instructions, wherein execution of the instructions by a processor causes the processor to:
ray trace planes of objects;
estimate a point spread function from the ray tracing;
create one or more perceived images;
implement a blurring effect;
implement a noise tradeoff;
feed the perceived images into a perception pipeline;
generate synthetic imagery from the perceived images;
incorporate optical effects into the generated synthetic imagery;
render one or more photo-realistic scenes on the generated synthetic imagery, wherein an imaging sensor is located within a cabin of the vehicle; and
feed a ray-tracing simulator with one more synthetic impulse images or scenes.

14. The non-transitory computer-readable storage medium on which is recorded instructions of claim 13, further comprising:
generating the point spread function sampled at multiple locations in one or more frames.

15. A method for simulating images with aberrations, comprising:
ray tracing planes of objects to produce plane images;
feeding a ray-tracing simulator with one or more synthetic impulse images or scenes;
estimating a point spread function from the ray tracing;
creating one or more perceived images;
feeding the perceived images into a perception pipeline;
generating synthetic imagery from the plane images and the perceived images;
providing an actual imaging sensor of a vehicle; and
incorporating optical effects into the generated synthetic imagery.

16. The method of claim 15, wherein the imaging sensor of the vehicle is located within a cabin of the vehicle.

17. The method of claim 16, wherein test-drives are not needed for data collection due to the generated synthetic imagery.

18. The method of claim 17, further comprising:
rendering one or more photo-realistic scenes on the generated synthetic imagery.

19. The method of claim 18, further comprising:
implementing a blurring effect; and
implementing a noise tradeoff.
